(19) United States
(12) Patent Application Publication
(10) Pub. No.: US 2021/0074472 A1
(43) Pub. Date: Mar. 11, 2021

(54) THERMALLY CONDUCTIVE COMPOSITE DIELECTRIC MATERIALS

(71) Applicants: Marvis WHITE, Lexington, KY (US); Andrew HUNT, Lexington, KY (US); ENGI-MAT Co., Lexington, KY (US); NGIMAT CO., Norcross, GA (US)

(72) Inventors: Marvis White, Lexington, KY (US); Andrew Hunt, Lexington, KY (US)

(21) Appl. No.: 16/977,984

(22) PCT Filed: Mar. 8, 2019
(86) PCT No.: PCT/US2019/021258

§ 371 Date: Sep. 3, 2020

Related U.S. Application Data
(60) Provisional application No. 62/640,771, filed on Mar. 9, 2018.

(51) Int. Cl. H01F 27/32; H01F 27/28; H01F 5/06; C04B 35/583; C04B 35/626; C04B 35/634

(52) U.S. Cl. CPC H01F 27/324; H01F 27/2823; H01F 5/06; C04B 2235/786; C04B 35/6264; C04B 35/63468; C04B 35/583

(57) ABSTRACT

Composites with high thermal conductivities and high loadings of hexagonal boron nitride particles in an organic polymer matrix are provided. Also provided are thermally conductive, electrically insulating coatings for magnet wires made from the composites and thermally conductive, electrically insulating infills for windings made from the composites.

### CROSS-REFERENCE TO RELATED APPLICATIONS

The present application claims priority to U.S. provisional patent application No. 62/640,771 that was filed Mar. 9, 2018, the entire contents of which are hereby incorporated herein by reference.

### REFERENCE TO GOVERNMENT RIGHTS

This invention was made with government support under DE-SC0009482 by the Department of Energy. The government has certain rights in the invention.

### FIELD OF THE DISCLOSURE

The present disclosure is directed to inorganic particle-loaded polymer composites that may be used in a variety of applications, including as magnet wire insulation and infill for windings, including motor windings, to provide benefits that include lowered motor temperatures, increased motor power per weight, longer life, and increased operating efficiency.

### BACKGROUND

In 2013, the APEEM (Advanced Power Electronics and Electric Motors) program of the U.S. Department of Energy (DOE) Vehicles Technologies Office stated goals for all-electric vehicle drive systems to have by 2020 a cost reduction of a factor of 4, a 35% size reduction, a 40% weight reduction, and a 40% loss reduction relative to what existed in 2012. The targeted electric motor contributions to those goals were to cut cost/kW by half and increase specific power (kW/kg) by 30%. Among the key strategies stated by the DOE for achieving those goals was to improve heat transfer and thermal management.

All of the loss mechanisms in an electric motor (copper resistive loss, core losses, friction, wind resistance, etc.) produce heat. The upper temperature limits for winding wire insulation, other insulation materials, and for magnets in the case of permanent magnet motors, define the short-term and long-term peak power levels at which a motor can be run without damage. The better the heat extraction is from the motor, the lower the temperatures are at a given power, and the higher is the allowable peak power. Or with better heat extraction, if the goal is reduced size and weight instead of to provide more power, a smaller motor can be run at higher current to produce the same power without exceeding thermal limits.

Most commercial magnet wire insulations consist of neat polymers. However, inorganic materials have been added to polymers to enhance their mechanical and electrical performance and to provide higher thermal conductivity, enabling the removal of heat generated in the operation of magnetic field generating wound wire coils. For relatively small motors relevant to electric vehicles, the insulation is applied as a coating and is termed film insulation. Stationary and traction motors above a certain size primarily use tape wound or braided insulation, the tape being variously paper, fiberglass, neat polymer, or polymer filled with mica or other inorganic particulate (e.g., glass, silica, or mullite fiber, or glass, or silica particle-filled polymer fiber). Film coated magnet wire is classified by wire gauge, insulation build (single, heavy, triple, or quadruple), polymer type, and thermal class, the classifications being set by standards such as ANSI/NEMA MW 1000 in the United States or the international IEC 60317 standards. In most common use today for electric vehicle traction motors is polyesterimide (PEI) overcoated with polyamideimide (PAI), the combination being a class 220 insulation. The basecoat is principally for electrical insulation and the overcoat for scrape resistance.

A variation on that PEI/PAI insulation is inclusion in the PEI base of a uniform dispersion of a few percent of inorganic particles for protection against partial discharge (PD) (corona) damage in inverter powered motors. Most major magnet wire suppliers have a version of that PD resistant insulation. Generally, these surge-resistant materials have low particle loadings. However, they are not intended for and do not provide significant improvement in thermal conductivity.

### SUMMARY

Thermally conductive materials, magnetic wires having thermally conductive coatings, thermally conducting infill materials for magnetic windings, and magnetic windings coated by the infill materials are provided. The coatings and infill materials are composite materials with high thermal conductivities and high loadings of hexagonal boron nitride (hBN) particles in an organic polymer matrix.

One embodiment of a thermally conductive material includes: hexagonal boron nitride particles having an average size in the range from 3 μm to 7 μm dispersed in a polyimide, wherein the loading of the hexagonal boron nitride particles in the thermally conductive, dielectric coating is at least 25 vol. %, based on the total volume of the hexagonal boron nitride particles and the polyimide.

One embodiment of a magnetic wire includes: a metal wire; and a thermally conductive, dielectric coating on the external surface of the metal wire. In this embodiment, the thermally conductive, dielectric coating includes hexagonal boron nitride particles having an average size in the range from 3 μm to 7 μm dispersed in a polyimide, wherein the loading of the hexagonal boron nitride particles in the thermally conductive, dielectric coating is at least 25 vol. %, based on the total volume of the hexagonal boron nitride particles and the polyimide. The magnetic wire is able to pass all of following tests, as published by the National Electrical Manufacturers Association in 2011: NEMA MW 1000-3.3.1; NEMA MW 1000-3.5; NEMA MW 1000-3.8.3; NEMA MW 1000-3.9.2; NEMA MW 1000-3.10; NEMA MW 1000-3.50; NEMA MW 1000-3.52; and NEMA MW 1000-3.59.

One embodiment of a magnetic winding includes: a coiled magnetic wire; and a thermally conductive infill material in thermal contact with the coiled magnetic wire. In this embodiment, the thermally conductive infill material includes hexagonal boron nitride particles having an average size in the range from 3 μm to 7 μm dispersed in an epoxy resin, wherein the loading of the hexagonal boron nitride particles in the thermally conductive, infill material is at least 25 vol. %, based on the total volume of the hexagonal boron nitride particles and the epoxy resin.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings.

FIG. 1 shows the thermal conductivity as a function of particle loading (volume fraction), according to the Bruggeman model.

FIG. 2 depicts thermal endurance data and the resulting thermal index for an hBN-polyimide wire insulation having a thickness of 20 μm.

### DETAILED DESCRIPTION

Composites with high thermal conductivities and high loadings of hexagonal boron nitride (hBN) particles in an organic polymer matrix are provided. Also provided are thermally conductive, electrically insulating coatings for magnet wires made from the composites and thermally conductive, electrically insulating infills for motor windings, including electric vehicle motor windings, made from the composites. Notably, despite the high hBN filler content, the resultant materials, wire insulation coatings and infill materials do not suffer the expected detrimental impact to their performance, which has historically been observed upon attempts to increase loading of thermally conductive filler particles in polymer matrices. For example, the wire insulation coatings described herein are able to meet the required mechanical, thermal, and electrical characteristics per the American National Standards Institute/National Electrical Manufacturers Association (ANSI/NEMA) magnet wire standards. The coatings provide improved heat dissipation and, thus, lowered motor temperatures, increased motor power per weight, longer life, and increased operating efficiencies.

The thermal conductivity of at least some polymers can be enhanced by dispersing thermally conductive particles in the polymers; however, there is a practical upper limit to the particle loading in known magnet wire insulations because, above a certain particle loading, critical properties including voltage breakdown, continuity, dissipation, and/or flexibility are negatively affected. The effect of particle loading on thermal conductivity can be understood in terms of the Bruggeman model. The Bruggeman model is a well-known mathematical formalism. (See, for example, Barber et al., Materials 2009, 2, 1697-1733.) The Bruggeman model allows one to estimate many effective properties of heterogeneous materials, including thermal conductivities.

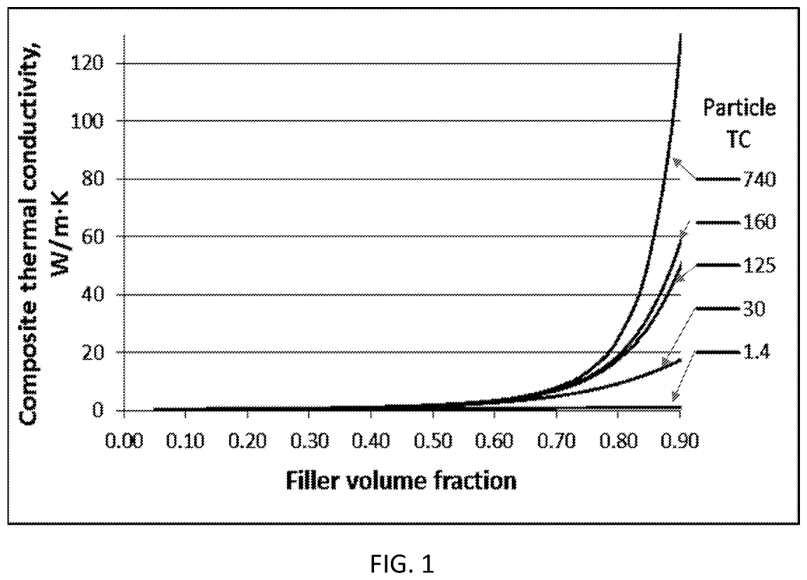

FIG. 1 shows the thermal conductivity as a function of particle loading (volume fraction), according to the Bruggeman model, for composites made from ideally dispersed, spherical particles in a polymer for particles having thermal conductivities ranging from 1.4 to 740 W/m·K. It can be seen that for particle loadings up to about 60 vol. % and particle thermal conductivities below about 30 W/m·K, it makes little difference what the thermal conductivity of the particles is because they are separated and cannot readily transfer heat from one particle to another. Therefore, from a thermal conductivity perspective, it can be advantageous to use high particle loadings. However, increased particle loading results in a decrease in polymer matrix loading, and at high particle loadings the properties of the inorganic particles can overwhelm the properties of the polymer matrix that are needed for a coated magnet wire to function properly. Thus, the development of magnet wire insulation or winding infill materials with high particle loadings has not been realized because the high loadings required to achieve high thermal conductivities tend to render the infill materials and the insulated magnet wires incapable of meeting industry standards, including the ANSI/NEMA magnet wire standards. As a result, magnet wire insulation, winding infills, and related materials typically have a thermally conductive particle loading of less than 35 wt. % and, more typically, substantially less than 35 wt. %.

One aspect of the invention provides composites that address the above-mentioned limitations based, at least in part, on the discovery that hBN particles having appropriate morphologies, sizes, and surface bonding characteristics can be added to conductive polymers, such as polyimides and epoxy polymers, at high loadings and still provide thermally conductive materials that meet required industry standards. Some embodiments of the materials have thermal conductivities that are more than three times higher than those of the conductive polymers alone. This includes embodiments of the materials having thermal conductivities that are more than four times higher than those of the conductive polymers alone and further includes embodiments of the materials having thermal conductivities that are more than five times higher than those of the conductive polymers alone.

One embodiment of a composite that can be used as a magnet wire insulation is composed of hBN particles in a thermally conductive, electrically insulating polymer and includes at least 25 volume percent (vol. %) (i.e., at least about 40 weight percent (wt. %)) hBN particles, based on the total volume of the hBN particles and the polymer. This includes composites that include at least 35 vol. % (i.e., at least about 51 wt. %) hBN particles, based on the total volume of the hBN particles and the polymer, and further includes composites that include at least 45 vol. % (i.e, at least about 61 wt. %) hBN particles, based on the total volume of the hBN particles and the polymer. By way of illustration, some embodiments of the wire coatings have an hBN loading, based on the total volume of the hBN particles and the polymer, in the range from about 25 vol. % to about 50 vol. % (i.e., from about 40 wt. % to about 66 wt. %). This includes embodiments of the wire coatings that have an hBN loading, based on the total volume of the hBN particles and the polymer, in the range from about 25 vol. % to about 45 vol. % and further includes embodiments of the coatings that have an hBN loading, based on the total volume of the hBN particles and the polymer, in the range from about 25 vol. % to about 40 vol. %. The thermally conductive, electrically insulating polymer can be a polyimide.

The hBN particles used in the developed materials, including magnet wire coatings and winding infill compositions, include hBN particles with an average particle size (APS) in the range from 2 μm to 8 μm. This includes hBN particles having an APS in the range from 3 μm to 7 and further includes hBN particles having an APS in the range from μm 5 μm to 6.5 μm, including the range from 4.5 μm to 6 μm. The hBN particles may have a platelet morphology (i.e., hBN “flakes”), in which the width and length dimensions of the particle are many times greater than the thickness (e.g., at least five time greater, at least ten times greater, at least 100 times greater, or at least 1000 time greater). hBN platelets sold under the name NX5 by Momentive Performance Materials are an example of commercially available hBN particles that can be used. For platelet particles, the APS values recited herein refer to the size of the width dimensions, rather than the thickness dimensions. Without intending to be bound to any particular theory of the invention, it is believed that these hBN particles are able to form a percolative path for phonon transfer through the thickness of the insulation even at the loading limits recited above.

The polyimides can be a pre-imidized polyimide or a non-pre-imidized polyimide or, at least, a polyimide that is not fully pre-imidized. Imidization can be carried out via a cure during the wire coating process. Coatings made using a non-pre-imidized polyimide can provide higher flexibilities and dielectric strengths. The polyimide sold under the name Pyre M.L. RC 5057 by Industrial Summit Technology is an example of a commercially available polyimide that can be used.

The coatings can be applied to a variety of metal wires, such as copper wires and aluminum wires, that are commonly used as magnet wires in motor windings. These wires are characterized in that they create an electromagnetic field when wound into a coil and energized. In addition to motor windings, the magnetic wires can be used in the windings of transformers, inductors, generators, and related equipment.

The coatings can be applied by preparing a slurry of the hBN particles and the polymer in an organic solvent or a mixture of organic solvents. Coating slurries can be made, for example, by using a high intensity ultrasonic probe to disperse dry hBN powder in a solvent or solvent mixture containing a dispersant, adding the polymer solution, and mixing again. Prior to adding the hBN powder, immiscible solvents can be mixed and dispersants can be solvated by agitation (e.g., sonication). The polymer can then be added to the resulting hBN dispersion, preferably beginning with small increments (e.g., drops), as the mixture is sonicated and then mixed. Mixing can be done by a combination of Thinky (a brand of asymmetrical centrifugal mixer) mixing and rolling in a plastic container containing zirconia grinding media. Slurries with particle loadings between 20 and 60 vol. % (i.e., about 33 wt. % to about 75 wt. %) can be made in this manner for wire coating. Once formed, the composition can be applied as a coating around a magnet wire using a wire enameling process, such as die coating. The resulting coating then can be cured or simply dried. The solvents should be selected such that they dissolve the polymer used as the composite matrix and disperse the hBN particles without any significant aggregation. Examples of suitable organic solvents for a slurry of the hBN particles and a polyimide polymer include N-methylpyrrolide (NMP), naptha, or a mixture thereof. In addition to the hBN particles, the polymer, and the solvents, other additives may be included in small quantities—typically at quantities of 1 vol. % or less. For example, a small amount of a dispersant can be included in the slurry. After drying, some embodiments of the coating consist essentially of the hBN particles and the polymer. A coating can be considered to consist essentially of the hBN particles and the polymer if the only other ingredients present are impurities (for example, impurities present in the starting materials as they are sold commercially), solvents that have not undergone complete evaporation during drying, and/or small quantities of additives used to help disperse the hBN particles (for example, dispersants). Typically, for a coating that consists essentially of the hBN particles and the polymer, the hBN particles and the polymer will make up at least 98 vol. % of the coating, including at least 99 vol. %, at least 99.5 vol. %, and at least 99.9 vol. %.

The thickness of wire coatings can be controlled during the coating process. In various embodiments of the present magnetic wire coatings, the coating is in the range from 15 μm to 45 μm. This includes wire coatings having thicknesses in the range from 20 μm to 30 μm and in the range from 20 μm to 25 μm.

Embodiments of the magnet wires coated with the hBN particle containing composites described herein are characterized in that they pass all of the following tests under ANSI/NEMA MW 1000 for magnet wire: (1) adherence and flexibility (NEMA MW 1000-3.3.1); (2) heat shock (° C.) (NEMA MW 1000-3.5); (3) dielectric breakdown (V) (NEMA MW 1000-3.8.3); (4) continuity, faults/100 ft. (NEMA MW 1000-3.9.2); (5) dissipation factor (%) (NEMA MW 1000-3.10); (6) thermoplastic flow, (° C.) (NEMA MW 1000-3.50); (7) dielectric breakdown at 250° C. (V) (NEMA MW 1000-3.52); and (8) scrape resistance (grams to fail) (NEMA MW 1000-3.59). The requirements for passing these tests are listed in Table 2 of Example 1. The tests under ANSI/NEMA MW 1000 are published by NEMA and approved by ANSI; for the purposes of this disclosure, the ANSI/NEMA MW 1000 tests refer to those published in 2011, which is incorporated herein by reference for the purpose of defining the tests. For applications with lower tolerances, the magnet wire coatings can be formulated such that the coated magnet wires pass at least six of the eight above-referenced NEMA tests or, more desirably, pass at least seven of the eight above-referenced NEMA tests.

Other criteria that the insulating magnet wire coatings may meet, but are not required to meet under NEMA MW-1000, include a thermal conductivity of at least 0.8 W/m K (including a thermal conductivity of at least 1 W/m K), a thermal index of at least 250° C. (including a thermal index of at least 280° C.), a concentricity as measured by displacement of a bare wire and coating centroids of no greater than 3 μm, and/or a pinhole continuity that meets the standard of IEC test 60317-0-1, clause 23 (2013).

Another aspect of the present invention provides composites that can be used as infill for motor windings and other windings. The infill composite can be molded around the end turns of the motor windings or entirely around the stator core and/or can be used to fill the spaces between the wires within the slots.

One embodiment of a composite for use as an infill is composed of hBN particles in a thermally conductive, electrically insulating epoxy polymer and includes at least 25 volume percent (vol. %) (i.e., at least about 40 wt. %) hBN particles, based on the total volume of the hBN particles and the epoxy. This includes embodiments of the infill that include at least 30 vol. % (i.e., at least about 46 wt. %) hBN particles, based on the total volume of the hBN particles and the epoxy, at least 35 vol. % (i.e., at least about 51 wt. %) hBN particles, based on the total volume of the hBN particles and the epoxy at least 40 vol. % (i.e., at least about 56 wt. %) hBN particles, based on the total volume of the hBN particles and the epoxy, at least 45 vol. % (i.e., at least about 61 wt. %) hBN particles, based on the total volume of the hBN particles and the epoxy and at least 50 vol. % (i.e., at least about 66 wt. %) hBN particles, based on the total volume of the hBN particles and the epoxy. By way of illustration only, some embodiments of the infill composite include 30 vol. % to 50 vol. % hBN particles, based on the total volume of the hBN particles and the epoxy.

Suitable epoxy polymers include the epoxy sold under the name Dolphon CC-1105-LV by Dolph's. Embodiments of the infill composites can be produced with a thermal conductivity greater than 1 W/m·K, including embodiments having a thermal conductivity of at least 3 W/m·K. Some embodiments of the infill provide a cross-slot winding thermal conductivity increase of at least 2 W/m·K. This includes embodiments of the infill composites that provide a cross-slot thermal conductivity increase of at least 5 W/m·K.

As in the composites for magnet wire coatings, the hBN particles that can be used in the infill composites include those having a platelet morphology and an average particle size (APS) in the range from 4 μm to 6.5 μm, including the range from 4.5 μm to 6 μm.

The infill composite can be formulated simply by mixing the hBN particles with the epoxy polymer to form a thermally conducting composition. No solvents are required. The use of a solventless infill composition is desirable because there are no solvents present that might be incompatible with the insulation on the magnet wires. Thus, the infill and the magnet wire coatings can be used together to provide electric motors with enhanced thermal properties and improved performance. The infill can be applied to a winding, including a motor winding, by, for example, dip winding or co-application during winding.

After drying, some embodiments of the infill material consist essentially of the hBN particles and the epoxy resin. An infill material can be considered to consist essentially of the hBN particles and the epoxy if the only other ingredients present are impurities (for example, impurities present in the starting materials as they are sold commercially. Typically, for an infill that consists essentially of the hBN particles and epoxy, the hBN particles and the epoxy will make up at least 98 vol. % of the coating, including at least 99 vol. %, at least 99.5 vol. %, and at least 99.9 vol. %.

### EXAMPLES

### Example 1: Dielectric Magnet Wire Insulation

This example illustrates the development, testing, and performance of electrically insulating (dielectric) coatings for magnet wires that incorporate hBN platelets in a polyimide polymer composite. As illustrated by the results reported herein, advantages/properties provided by the coatings include: a continuous power output increase of at least 36%; a wire insulation coating with a thickness of 25 μm passing all ANSI/NEMA 1000 MW requirements, plus additional tests (see Table 2); a thermal index of 281° C., which represents a 41° C. increase over the same neat polyimide polymer; and thermal conductivities of 0.81 W/m·K.

The slurry formulation used to make the wire insulation is shown in Table 1. A polyimide resin (RI) was used as the polymer component due to its high dielectric strength, high service temperature, and its enablement of fast drying and, therefore, fast wire coating speeds. The hBN was supplied as a dry powder.

TABLE 1
Wire coating formulation with 37.5 vol.
% hBN product NX5 from Momentive.

| | Grams for | Density | Commercial |
|---|---|---|---|
| Component | 18 L | {g/cm³) | Source |
| Pyre-ML polyimide RC 5057 | 14422.4 | 1.05 | 1ST |
| filler, hBN, NX5 | 2063.4 | 2.1 | Momentive |
| Solvent, NMP | 12940.7 | 1.028 | Avantor |
| Solvent, Naptha | 3235.1 | 0.87 | Nelson Paint Co. |
| dispersant, PVP | 27.8 | 1.2 | Sigma Aldrich |

A mixture of NMP and naptha was used as a solvent mixture due to the ability of these solvents to dissolve the polymer and to well disperse the hBN particles. Evaporation of the solvent from the slurry coating on the wire occurred as the wire traveled through drying furnaces.

Coating slurries were made by using a high intensity ultrasonic probe to disperse dry filler in solvent, containing a dispersant (PVP; polyvinyl-pyrrolidone), adding polymer solution, and mixing again. Mixing was done by a combination of Thinky (a brand of asymmetrical centrifugal mixer) mixing and rolling in a plastic container containing zirconia grinding media.

The wire that was coated was 20 AWG round copper, a typical wire size used in electric vehicle (EV) motors. Before coating, wire cleaning was done offline with a separate wire cleaning system, in which wire moved spool-to-spool through an ultrasonic cleaning bath and then through a purpose-made spiral brush that scrubbed soils and copper dust from the wire within the ultrasonic bath. Having a clean copper surface was helpful in achieving the desired wire properties to pass all the performance tests.

Die coating was used to apply the coating to the wire. Instead of the entire coating being applied in one passage through the slurry, as is typically the case with dip coating, die coating builds up a number of thin layers using a succession of increasing die sizes. Since coating concentricity influences properties such as breakdown, continuity, and flexibility, the use of die coating results in good coating quality.

Listed in Table 2 are the magnet wire properties tested in this example, along with the values or conditions required to pass various standard tests for magnet wires. Table 2 also lists typical values for the coated copper wires. All of the tests listed, except thermal conductivity, concentricity, and pinhole continuity, are required tests under ANSI/NEMA MW 1000. MW 1000 does not directly give any specification for film insulation containing fillers. Yet MW 1000 is inclusive of film insulation with fillers, in that it allows any variation on a basic insulation type, so long as the modified insulation meets the requirements for the unmodified insulation. Thus, the high thermal conductivity (TC) insulation in this example should meet the requirements for film-coated polyimide as given in MW 16-C (a specification within the umbrella of MW 1000).

TABLE 2
Magnet wire property tests.

| | | | Typical |
|---|---|---|---|
| Property | Test | Requirement | Value |
| Thickness, μm | Optical micrometer | 15 < Thinnest | 25 |
| | | possible < 30 | |
| Thermal conductivity, | Hodgetts method | Maximized | 0.8 |
| W/m · K | | | |
| Thermal Index, ° C. | ASTMD 2307 | 250 | 281 |
| Concentricity, μm | Displacement of bare wire and | ≤3 | 1.5 |
| | coating centroids; av. from 3 | | |
| | polished cross-sections | | |
| Adherence and | NEMA MW1000-3.3.1 | 20% jerk, 3d wind | Passed |
| flexibility, Pass/Fail | | | |
| Heat Shock, ° C. | NEMA MW1000-3.5 | 3d wind, 280° C., | Passed |
| | | 30 min., no cracks | |
| Dielectric breakdown, V | NEMA MW1000-3.8.3 | 3010 | 4450 |
| Pinhole continuity, # of | IEC 60317-0-1 Clause 23 | 0 | 0 |
| pinholes | | | |
| Continuity, faults/100 ft | NEMA MW1000-3.9.2 | | |
| Dissipation factor, % | NEMA MW1000-3.10 | ≤0.6 | ~0.3 |
| Thermoplastic flow, ° C. | NEMA MW1000-3.50 | ≥450 | 612 |
| Solubility, Pass/Fail | NEMA MW1000-3.51 | NEMA MW16-C | Passed |
| Dielectric breakdown at | NEMA MW1000-3.52 | ≥2258 | 3122 |
| 250° C., V | | | |
| Scrape resistance, grams | NEMA MW1000-3.59 | NEMA MW16-C | 1243 g avg., |
| to fail | | 560 g avg., 475 g | 1164 g |
| | | minimum | minimum |

The standardized tests in Table 2 were carried out according to their published test procedures. Some details regarding the testing procedures are provided below.

Measuring Insulation Thickness:

Prior to beginning a wire coating run, the entire length of bare wire to be coated was traversed through an optical micrometer of a wire coating system for measurement of its diameter. The micrometers have an accuracy of 0.5 μm and measure at a rate of 2400 times/sec. During coating application, after exiting each coating pass, the diameter was again measured. Subtraction of the average bare diameter, and division by two, gave the approximate coating thickness. The average total thickness and thickness gain for each layer was recorded and used as the basis for determining when the target thickness was reached. However, measurement by optical micrometer before and after coating did not give quite the true coating thickness as a result of wire stretching and thinning as it moved under tension through between 4 and 13 heated drying passes, depending on final thickness. Despite all the measures taken to minimize stretching by minimizing tension, a small amount of wire stretching/thinning is unavoidable. Thus, after coating, actual final thickness was determined microscopically from three cut and polished cross-sections.

Measuring Thermal Conductivity:

Pucks of the wire coating composition on the order of 1 mm thick were cast and used for measurement of thermal conductivity by the laser flash technique.

Measuring Thermal Index:

Thermal endurance testing of the coated magnet wire was done for the purpose of determining the thermal index, which is essentially the maximum continuous use temperature. Testing was done with three exposure temperatures (300, 320, and 340° C.), and four thicknesses (15, 25, 35, and 45 μm) of the coating. NEMA MW 1000-3.58.1 requires testing to be conducted according to ASTM D 2307. Ten wound wire pairs were mounted on a test rack, as directed by the standard, and exposed in air to elevated temperatures in a forced convection oven. According to the method, after various periods of time, the pairs were taken out of the oven and subjected to a proof voltage of 24 V/μm of insulation thickness. Exposure and testing at each temperature were continued until more than half of the set had broken down. The endurance life and temperature data were then plotted as an Arrhenius graph (log time versus 1/T). The temperature at which a straight line fitted through the data crosses 20,000 hours was taken as the insulation thermal index.

Measuring Concentricity:

The same sectioned and polished cross-sections used to measure insulation thickness were used to measure insulation concentricity. Concentricity means the degree to which the insulation is the same thickness all around the wire circumference. In observing the cross-section of an insulated wire, concentricity was measured as the displacement between the centroid of the copper wire and the centroid of the insulation outer diameter. Using a microscopic image of the cross-sectioned insulated wire, image analysis software was used to fit circles to the wire outer diameter (OD) and the insulation OD. The software displayed the distance in micrometers between the centers of the two circles. ≤3 μm was taken to be the criteria for adequate concentricity.

Measuring Adherence and Flexibility:

As prescribed by NEMA MW 1000-3.3.1, the adherence and flexibility test for 13.5-30 AWG insulated copper wire consists of taking a 10-inch piece of wire, elongating it by 20% in a sudden jerk, and then winding it around a mandrel 3 times the diameter of the copper wire, i.e. 3d. The test is passed if no cracks in the insulation can be seen by normal vision, i.e. without aid of magnification. Since visual acuity varies person to person, for less subjectivity, the test was said to be passed if open cracks (revealing copper) were not visible at a magnification of 1.5×.

Measuring Heat Shock:

Heat shock measures the effect of heat exposure in air on adherence and flexibility. NEMA MW 1000-3.5.1 requires the wire to be stretched 20% and wound on a 3d mandrel in the same manner as for the adherence and flexibility test. It is exposed in a forced air circulation oven for 30 min., taken out, cooled to room temperature, and observed for cracks in the insulation. The exposure temperature is specific to the insulation material, being 280° C. for polyimide.

Measuring Dielectric Breakdown:

Voltage breakdown was determined according to NEMA MW 1000-3.8.4, the wound pair method. A length of insulated wire is draped over a hook with weights attached to each end. By rotating the hook and incrementing downward a bar between each rotation, the wire is wound up itself. The weights, the incrementing distance, and the number of turns within a 4¾-inch length are prescribed in the standard based on the wire gauge. By cutting open the wire loop at the top and unwinding a few turns until the 4¾-inch length is obtained, a wire test pair is obtained. While commonly called twisted wire pairs, these are differentiated from actual twisted pairs in that the wires are merely wound around each other and are not twisted about the wire axes. Test pairs were tested with the 60 Hz ac hipot tester, the voltage being ramped from zero at 500V/sec until breakdown. For the 20 AWG round copper wire used, the standard requires breakdown at 2:3010V for single build insulation (15-30 μm thick) and 2:5410V for heavy build insulation (30-45 μm thick). The hipot tester had an upper limit of 5100 V, precluding the proper testing of heavy build insulation. While the standard does not require or address the testing of multiple test pairs, 10 test pairs were tested to address statistical variability. The reported voltage breakdown result was the average for the 10 pairs. If a pair reached 5100 V without breaking down, a failure voltage of 5100 V was nevertheless recorded and the averaged result reported as “>xxxxV”.

Measuring Insulation Continuity:

Macroscopically incomplete wire insulation coverage would not normally exist. Instead, insulation continuity addresses the effect of small, usually microscopic, defects and thin spots in the insulation on electrical isolation. The NEMA continuity test (MW 1000-3.9.2) applies dc high voltage (1000 V for single build, 1500 V for heavy build) between an insulated wire and a graphite fiber brush through which the wire is pulled. For safety and simplicity, a different low voltage test method was used, called the salt bath pinhole test, that is not yet a NEMA standard method but is an international (IEC) standard method. The test involves placing a 5 m coil of insulated wire in a saturated salt solution containing phenolphthalein as an acid-base indicator. 12 VDC is applied between the copper wire and an electrode in the solution. If a pinhole is present in the insulation such that salt water can reach the wire, electrolysis occurs at the spot, hydrogen is evolved, and the phenolphthalein locally turns pink, marking the presence of the pinhole. The test is conducted for 2 minutes and the number of marked pinholes counted. The test is failed if any pinholes are present.

Next, NEMA MW 1000-3.9.2 high voltage dc continuity testing was conducted. The low voltage salt bath pinhole and high voltage continuity test results were found to agree very well.

Measuring Insulation Dissipation:

Dissipation factor, electrical loss in the insulation at higher frequencies, was measured according to NEMA MW 1000-3.10.4.2. An Au-bend piece of insulated wire was lowered into liquid gallium at 30-35° C., along with a bare copper wire as an electrode. The test wire and the electrode were connected to an LCR meter, from which the dissipation factor was read.

Measuring Thermoplastic Flow:

More commonly referred to as cut-through, this measurement, conducted according to NEMA MW 1000-3.50, is the temperature at which the insulation on two wires, one lying perpendicularly over the other and pressed together under a prescribed static load, is sufficiently penetrated to allow breakdown to occur between the two under a prescribed ac voltage, the load and voltage depending on wire gauge and insulation build. The test apparatus, with insulated wires installed, was heated in an oven with temperature increased at a prescribed rate until breakdown occurred. AC voltage was applied by and breakdown indicated by the hipot tester.

Measuring Solubility:

The applicable standard for the insulation, MW-16C, requires solubility testing with two solvents, xylene and 50/50 xylene/butyl Cellosolve (2-Butoxyethanol), one at a time, according to the method of NEMA MW 1000-3.51. The purpose of the test is to show the extent of insulation degradation by exposure to the solvents, as opposed to actual dissolution in the solvents. The method consists of a) stress annealing straight pieces of wire for 10 min at 150° C., b) immersion in the solvent at 60° C. for 30 min, c) scrape testing with an insulation scrape tester between 1 and 2 minutes after removal from the solvent, the scrape test being done with a 16 mil scraping wire moving along the insulated wire at 2 inches/second under a constant load prescribed according to the wire gauge and insulation build.

Measuring Dielectric Breakdown at Rated Temperature:

According to NEMA MW 1000-3.52, the rated temperature is to be the thermal class rating, which per MW 16-C is 240° C. for polyimide insulation. The thermal index for the insulation was indicated by thermal endurance testing to be 281° C. While the standard only required 240° C., testing was conducted at 250° C. in a convected air oven. Breakdown was measured with a hipot tester in the same manner as the room temperature breakdown test, with a requirement of >75% of the room temperature requirement, e.g. 75% of 3010V=2258V for single build insulation on 20 AWG round copper wire.

Measuring Scrape Resistance:

Insulation scrape resistance was measured according to NEMA MW 1000-3.59, which is a unidirectional, one-time scrape of the test insulated wire by a 9 mm scraper wire, moving at 16 inches/min and with a scraping load that is increased linearly until penetration of the insulation occurs. At penetration, traversal of the scraper wire is stopped and the load at that time recorded as the “grams-to-fail”. Each test wire piece is rotated about its axis and tested at each 120-degree orientation. While the NEMA test, being a conformance test of wire for sale, requires testing of only one wire piece, testing of four wire pieces was done to obtain a more statistically valid result.

Coating Thickness Testing:

The wire insulation material was coated at 4 thicknesses on 20 AWG round copper wire, 15 and 25 μm (single build), and 35 and 45 μm (heavy build). The coating with a thickness of 25 μm was identified as the best based on testing of room temperature breakdown, adhesion/flexibility, pinhole continuity, and high voltage DC continuity.

Thermal Endurance Test Results:

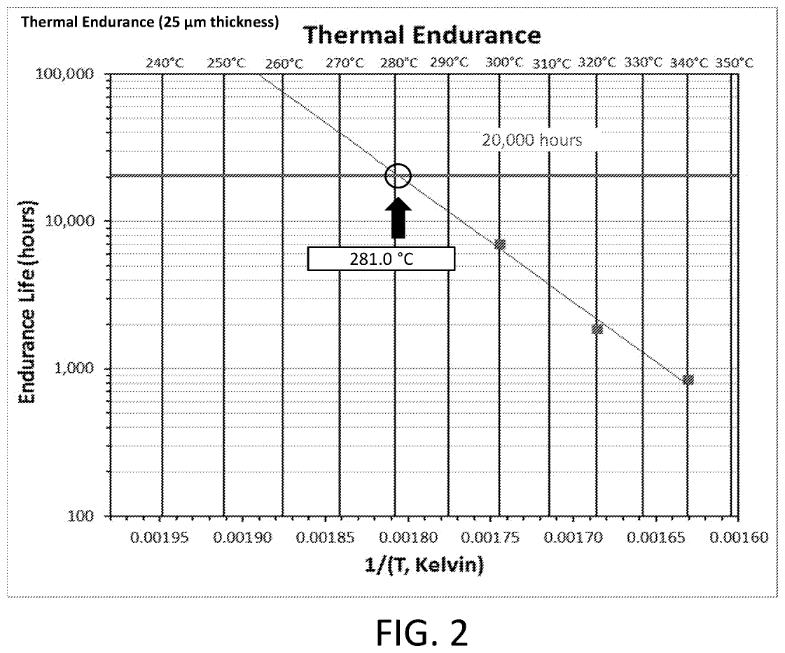

The purpose of thermal endurance testing was the determination of thermal indices (i.e. thermal ratings) for the experimental wire insulations. Per the definition, the thermal index is the temperature in air at which the wire insulation would have a 20,000-hour life. The indices determined for the wire insulation at 4 thicknesses are given in Table 3. At 25 μm and thicker, the filled insulation far surpasses unfilled aromatic polyimide. Polyimide has a thermal class of 240, meaning that its thermal index is a little above 240° C. Higher IEC thermal classes are in 25° C. increments (i.e. 250, 275, and 300° C.). Therefore, at 25 μm or thicker, the wire insulation would be rated as Class 275 insulations. The plotted thermal endurance data for the insulation is shown in FIG. 2. A class 275 rating facilitates conversion of liquid cooled motors into lighter, lower-cost air-cooled designs or increased power density without additional cooling requirements.

TABLE 3
Thermal index of hBN/polyimide composite
wire insulation of four thicknesses.

| 15 μm | 25 μm | 35 μm | 45 μm |
|---|---|---|---|
| 264.2 | 281.0 | 282.1 | 284.1 |

The insulation also has application in other extreme service conditions such as submersible pumps in oil/gas/geothermal wells and heavy-duty hand tools.

### Example 2. Motor Winding Infill

This example illustrates the use of a composite of 50 vol. % hBN platelet particles in an epoxy resin (Dolph C 1105-LV) as a slot filler. The properties for the coil impregnation material include: (1) as high thermal conductivity as possible; (2) a low enough viscosity to be applied with uniform coverage and without leaving gaps; (3) a thermal rating of at least 1 80° C.; (4) a long pot life (preferably an indefinite pot life owing to a single component, heat cured composition); (5) strength and rigidity after cure; and (6) the absence of voids that would be caused by the release of solvent or other volatile organic compounds.

These requirements were met by adding a high filler fraction of high thermal conductivity hBN particles (e.g., NX5 from Momentive) to a low viscosity, solventless, very low volatile organic compound (VOC) epoxy resin. Thermal conductivity of the cured impregnation composition was measured using cast discs of the composite by the laser flash method, at 3.0 W/m·K.

The resins were selected to have as low a room temperature (˜23° C.) viscosity as possible (500 cP or less), to be single component and heat curable in order to have long pot and shelf life, to be solventless, to have a thermal rating of at least 180° C., and to avoid bubble formation during curing when filled with the necessary high fraction of hBN filler particles (e.g., 50 vol. % or higher). Normally, impregnated resins are very low viscosity, allowing bubbles from solvent and VOCs to make their way out of the coil. With the high viscosity filled composition, escape of such bubbles is more difficult.

The effective cross-slot thermal conductivity of motor windings using the composite as a slot filler was measured, and a 10× effective cross-slot thermal conductivity increase (5.34 W/m·K compared to 0.516 W/m·K for standard motor insulators) was observed.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A magnetic wire comprising:
a metal wire; and
a thermally conductive, dielectric coating on the external surface of the metal wire, the thermally conductive, dielectric coating comprising hexagonal boron nitride particles having an average size in the range from 3 μm to 7 μm dispersed in a polyimide, wherein the loading of the hexagonal boron nitride particles in the thermally conductive, dielectric coating is at least 25 vol. %, based on the total volume of the hexagonal boron nitride particles and the polyimide,
wherein the magnetic wire passes all of following tests, as published by the National Electrical Manufacturers Association in 2011: NEMA MW 1000-3.3.1; NEMA MW 1000-3.5; NEMA MW 1000-3.8.3; NEMA MW 1000-3.9.2; NEMA MW 1000-3.10; NEMA MW 1000-3.50; NEMA MW 1000-3.52; and NEMA MW 1000-3.59.

2. The magnetic wire of claim 1, wherein the hexagonal boron nitride particles have an average size in the range from 4 μm to 6 μm.

3. The magnetic wire of claim 2, wherein the loading of the hexagonal boron nitride particles in the thermally conductive, dielectric coating is at least 35 vol. %, based on the total volume of the hexagonal boron nitride particles and the polyimide.

4. The magnetic wire of claim 2, wherein the thermally conductive, dielectric coating consists essentially of the hexagonal boron nitride particles and the polyimide.

5. The magnetic wire of claim 2, wherein the metal wire is a copper wire.

6. The magnetic wire of claim 2, wherein the thermally conductive, dielectric coating has a coating thickness in the range from 20 μm to 30 μm.

7. The magnetic wire of claim 2, wherein the thermally conductive, dielectric coating has a thermal index of at least 250° C.

8. The magnetic wire of claim 2, wherein the thermally conductive, dielectric coating has a thermal conductivity of at least 0.8 W/m·K.

9. The magnetic wire of claim 2, wherein the hexagonal boron nitride particles have a platelet morphology.

10. A motor comprising a motor winding, the motor winding comprising the magnetic wire of claim 1.

11. A winding comprising:
a coiled magnetic wire; and
a thermally conductive infill material in thermal contact with the coiled magnetic wire, the thermally conductive infill material comprising hexagonal boron nitride particles having an average size in the range from 3 μm to 7 μm dispersed in an epoxy resin, wherein the loading of the hexagonal boron nitride particles in the thermally conductive, infill material is at least 50 vol. %, based on the total volume of the hexagonal boron nitride particles and the epoxy resin.

12. The winding of claim 11, wherein the hexagonal boron nitride particles have an average size in the range from 4 μm to 6 μm.

13. The winding of claim 12, wherein the loading of the hexagonal boron nitride particles in the thermally conductive infill material is at least 35 vol. %, based on the total volume of the hexagonal boron nitride particles and the epoxy resin.

14. The winding of claim 12, wherein the infill material consists essentially of the hexagonal boron nitride particles and the epoxy resin.

15. The winding of claim 12, wherein the infill material provides a cross-slot winding thermal conductivity greater than 5 W/m·K.

16. The winding of claim 12, wherein the infill material has a thermal conductivity of 3 W/m·K or greater.

17. The winding of claim 12, wherein the hexagonal boron nitride particles have a platelet morphology.

18. The winding of claim 11, wherein the winding is a motor winding.

19. The winding of claim 11, wherein the coiled magnetic wire comprises:
a metal wire; and
a thermally conductive, dielectric coating on the external surface of the metal wire, the thermally conductive, dielectric coating comprising hexagonal boron nitride particles having an average size in the range from 3 μm to 7 μm dispersed in a polyimide, wherein the loading of the hexagonal boron nitride particles in the thermally conductive, dielectric coating is at least 25 vol. %, based on the total volume of the hexagonal boron nitride platelet particles and the polyimide.

20. The winding of claim 19, wherein the hexagonal boron nitride particles have an average size in the range from 4 μm to 6 μm.

21. The winding of claim 20, wherein the loading of the hexagonal boron nitride particles in the thermally conductive infill material is at least 35 vol. %, based on the total volume of the hexagonal boron nitride particles and the epoxy resin.
